(19) United States
(12) Patent Application Publication
(10) Pub. No.: US 2007/0155342 A1
(43) Pub. Date: Jul. 5, 2007

(54) Method and apparatus for adjusting frequencies of radio communication devices

(75) Inventors: Jeng Yi Tsai, Kaohsiung City (TW); Ganning Yang, Irvine, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/326,246

(22) Filed: Jan. 4, 2006

(51) Int. Cl. H04B 1/40

(52) U.S. Cl. 455/75

(57) ABSTRACT

Methods and systems with different control rates for uplink and downlink oscillators. The method comprises obtaining the frequency offsets between a receiver oscillator frequency and a carrier frequency of received signals, adjusting the receiver oscillator frequency at a first rate according to the frequency offsets, and adjusting the transmitter oscillator at a second rate according to the first rate. The receiver oscillator frequency is adjusted according to filtered frequency offsets, while the transmitter oscillator frequency is adjusted according to the frequency offsets and smoothed frequency offsets.

### BACKGROUND

The invention relates to controlling oscillators of transmitters and receivers, and practically, to auto frequency control of transmitters and receivers in a frequency division duplex (FDD) system.

In an FDD system, an uplink (UL) and a downlink (DL) radio channel between the base station (BS) and the mobile station (MS) are provided, as shown in FIG. 1a. Uplink indicates the direction from a mobile station to a base station, and downlink means the direction from a base station to a mobile station. FIG. 1b shows the frequency allocation of uplink and downlink channels in a GSM system. In a time division multiple access (TDMA) system, a mobile station tunes between the uplink and downlink frequencies to transmit and receive respectively.

For a single mobile station, the frequency deviation between the UL and DL is kept constant. To control the uplink transmitter and downlink receiver of a mobile station, an automatic frequency control (AFC) loop is required. FIG. 2a shows a conventional AFC loop. The frequency offset estimator 208 derives an estimation of frequency errors per TDMA frame according to the received downlink signal and delivers the estimation to loop filter 210 periodically. The loop filter 210 extracts the estimated frequency error trend. If the loop filter 210 indicates a positive frequency error, the frequency of downlink receiver oscillator 202 must be increased, and vice versa.

The estimated frequency error is quite noisy due to Doppler effects, corner effects, aging of radio frequency (RF) devices, fading conditions or measurement uncertainty. Doppler effects result from the movement of a mobile station, while corner effects occur when a mobile station turns around a corner or passes by a base station. A mismatch between received downlink frequency and carrier frequency generated by the receiver oscillator reduces communication quality. For better reception of downlink data, rapid adjustment of receiver oscillator frequency is required. Therefore, a fast correction loop for the downlink receiver path is preferred in AFC scheme. On the other hand, the variation of carrier frequency for uplink transmitter should be slow. If the variation of the carrier frequency of the uplink transmitter is too fast, a base station which received these signals would recognize the communication quality as bad and request re-transmission.

In the conventional AFC design as shown in FIG. 2a, the frequency offsets between the uplink transmitter frequency and the downlink receiver frequency is kept constant. FIG. 2b illustrates the relationship of uplink and downlink carrier frequency. The uplink transmitter oscillator frequency f_{C,UL} is always offset by the downlink receiver oscillator frequency f_{C,DL} with a constant frequency deviation f_{D}. In other words, the frequency deviation f_{D} equals f_{C,DL}−f_{C,UL}. The faster correction loop for the downlink receiver oscillator causes the change of uplink transmitter frequency in a fast manner and thus violates the behavior of uplink transmitter frequency adjustment.

Accordingly, methods and systems of individually adjusting downlink receiver oscillator and uplink transmitter oscillator are provided.

The invention provides a method for adjusting a transceiver, comprising obtaining the frequency offset between a receiver oscillator frequency and a carrier frequency of received signals, adjusting the receiver oscillator frequency at a first rate according to the frequency offset, and adjusting a transmitter oscillator frequency at a second rate according to the first rate. The receiver oscillator frequency is adjusted according to filtered frequency offset, while the transmitter oscillator frequency is adjusted according to the frequency offset and smoothed frequency offset.

An integrated circuit installed in a radio communication device, also provided by the invention, comprises a down-converter, a transmitter oscillator, a frequency offset estimating module, and a first and second smoothing module. The down-converter comprising a receiver oscillator generates a receiver oscillator frequency, and converts received signals into first signals. The frequency offset estimating module obtains the carrier frequency of received signals according to the received signals, and calculates frequency offsets between the carrier frequency of received signals and receiver oscillator frequency. The first smoothing module generates a first adjusting signal according to the frequency offset, wherein the first adjusting signal is sent to adjust the receiver oscillator frequency at a first rate. The second smoothing module receives the first adjusting signal to generate a second adjusting signal, wherein the second adjusting signal is send to adjust a transmitter oscillator frequency at a second rate. The transmitter oscillator generates the transmitter oscillator frequency, and transmitting second signals with the transmitter oscillator frequency to other radio communication devices.

It is noted that implementing the frequency offset estimating module, first and second smoothing modules are not limited to hardware. Other means which perform substantially the same functions are also in the scope of the invention. The frequency offset estimating module, first and second smoothing modules can be software and be executed by a digital signal processor.

### BRIEF DESCRIPTION OF THE DRAWINGS

The invention will become more fully understood from the detailed description, given herein below, and the accompanying drawings. The drawings and description are provided for purposes of illustration only, and, thus, are not intended to be limiting of the present invention.

FIG. 1a shows an uplink and a downlink radio channel between the base station and the mobile station;

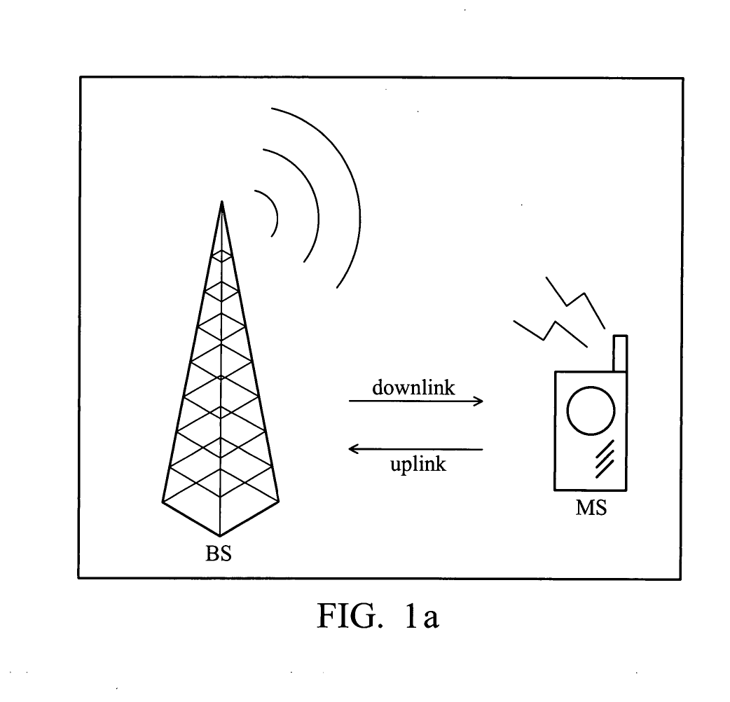

FIG. 1b shows the frequency band of uplink and downlink channels;

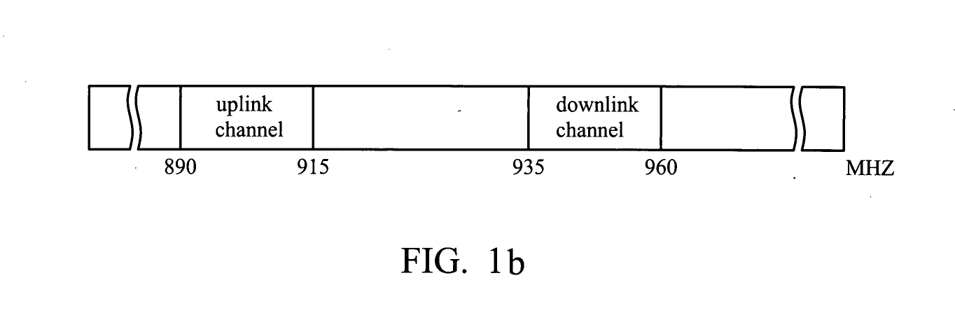

FIG. 2a shows a conventional AFC loop;

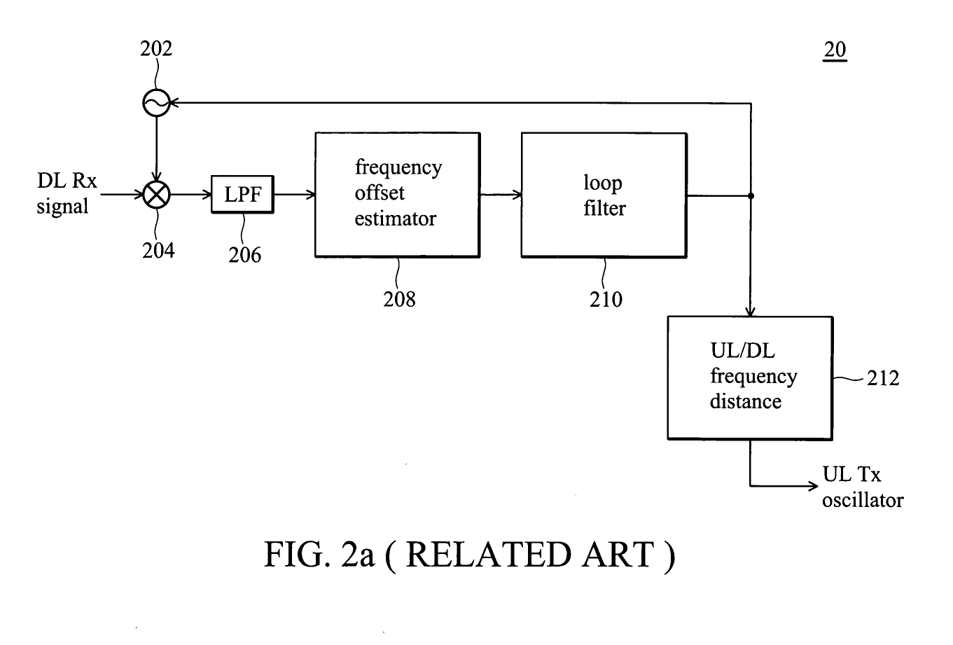

FIG. 2b illustrates the relationship of the uplink and downlink carrier frequency;

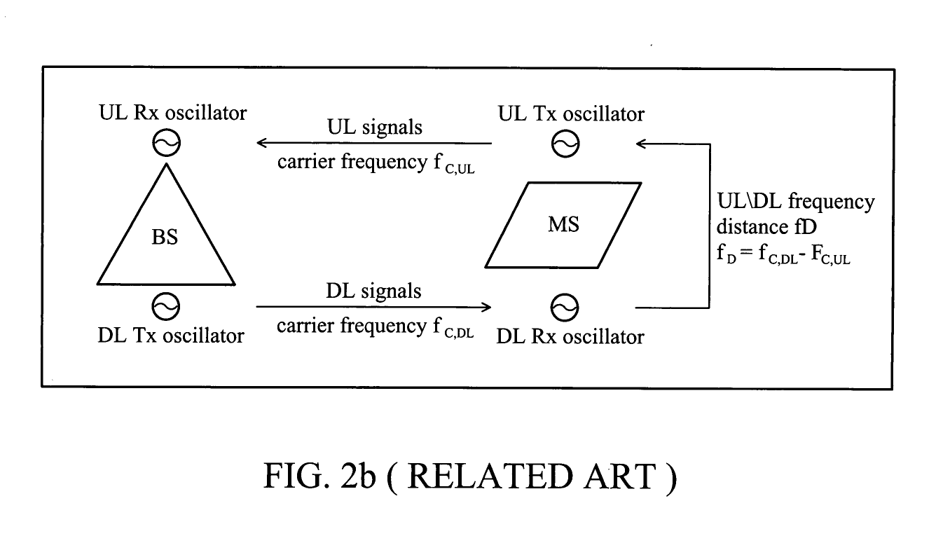

FIG. 3 shows a block diagram of an auto frequency control loop 30 according to an embodiment of the invention;

FIG. 4 shows a block diagram 40 of an auto frequency control mechanism according to another embodiment of the invention;

FIG. 5 shows a flowchart of controlling the oscillating frequency of the downlink receiver and uplink transmitter;

FIGS. 6a, 6b and 6c show three time diagrams of the frequency of the downlink receiver oscillator and uplink transmitter oscillator.

### DETAILED DESCRIPTION

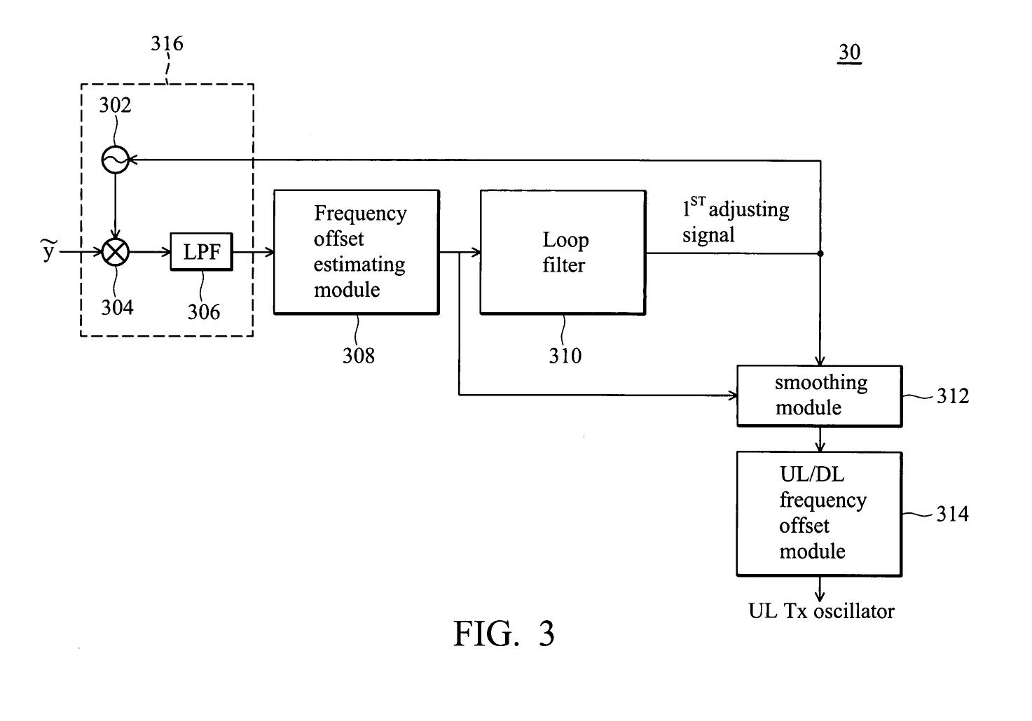

FIG. 3 shows a block diagram of auto frequency control loop 30 according to an embodiment of the invention. The control loop comprises a downlink receiver oscillator 32, a mixer 304, a low pass filter (LPF) 306, a frequency offset estimator 308, a loop filter 310, a smoothing module 312, and a UL/DL frequency offset module 314. In some embodiments of the invention, the downlink receiver oscillator 32, mixer 304 and the low pass filter 306 are combined as a down-converter 316, installed in an RF module. The downlink receiver oscillator 32 generates signals having a receiver oscillator frequency, and the down-converter 316 converts received signal \tilde{y} into a plurality of first signals. The frequency offset estimating module 308 estimates frequency offsets between the receiver oscillator frequency and the carrier frequency of \tilde{y} per TDMA frame. The loop filter 310 generates a first adjusting signal according to the frequency offsets. The first adjusting signal is sent to adjust the first frequency. The smoothing module 312 receives the first adjusting signal and the estimated frequency offsets to generate a second adjusting signal. A UL/DL frequency offset module 314 receives the second adjusting signal, and determines the receiver oscillator frequency a constant k, where k is the frequency deviation of the receiver oscillator frequency and transmitter oscillator frequency. A transmitter oscillator (not shown) generates the transmitter oscillator frequency, and transmits signals with the transmitter oscillator frequency to a corresponding communication device, such as, a base station.

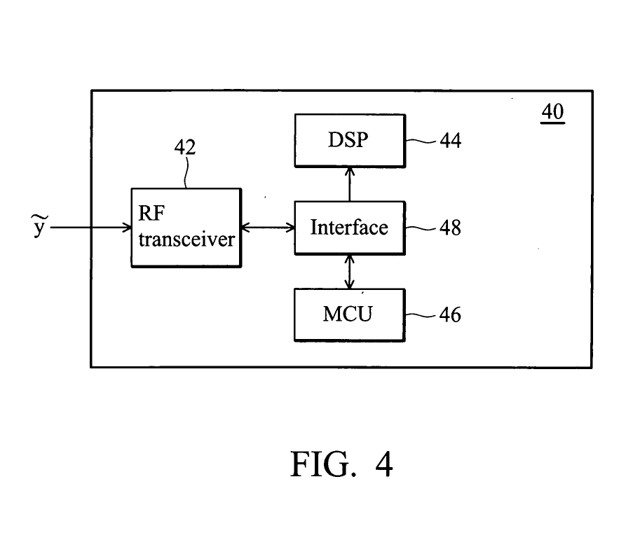

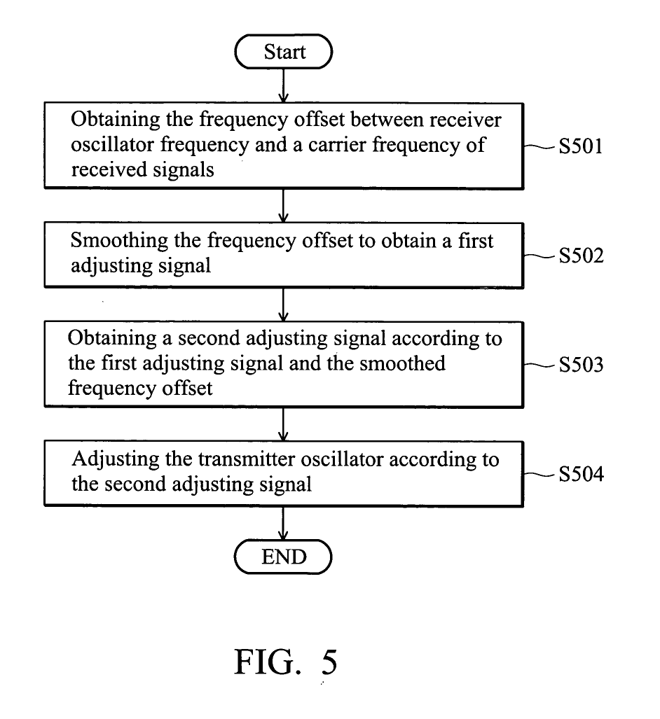

In this embodiment of the invention, the loop filter 310 extracts the estimated frequency offsets trend and adjusts the frequency of the downlink receiver oscillator 32 at a first rate, where “rate” means the change of frequency within a time unit. The smoothing module 312 extracts the trend of frequency offsets and the trend of the first adjusting signal to generate a second adjusting signal. Because the second adjusting signals pass one more module than the first adjusting signals, the adjustment rate of the transmitter oscillator is slower than the receiver oscillator. The operation of smoothing module 312 is similar to the loop filter 310. In other embodiments of the invention, the modules and blocks can be implemented in software. FIG. 4 shows a block diagram 40 of auto frequency control according to another embodiment, and FIG. 5 shows a flowchart of controlling the oscillating frequency of the downlink receiver and uplink transmitter. The RF transceiver 42 receives downlink signals and generates a receiver oscillator frequency to down-convert the received signals. The DSP 44 estimates the frequency offset per received TDMA frame. The DSP 44 executes estimation instructions to obtain the frequency offsets between a downlink receiver oscillator frequency f_{C,UL} and a carrier frequency of received signals \tilde{y}, as step S501 shown in FIG. 5. The estimation is delivered to the main control unit (MCU) 46 through the interface 48 between DSP 44 and MCU 46. The MCU 46 executes another instruction comprising smoothing the changes of the receiver oscillator frequency f_{C,UL} to obtain a first adjusting signal, as step S502, and then obtaining a second adjusting signal according to the smoothing frequency offset and the first adjusting signal, in step S503. After smoothing, the MCU 46 sends the adjustment amount to a transmitter oscillator of the RF transceiver 42 via the interface 48, as step S504. Finally, the uplink transmitter oscillator and downlink receiver oscillator are adjusted. In other embodiments of the invention, a filter can be used to smooth the frequency offset and the adjusting signal. As the second adjusting signal is “double smoothed”, the frequency of the uplink transmitter oscillator changes slower than the frequency of downlink receiver oscillator. In one embodiment of the invention, the RF transceiver includes two oscillators, one for transmitting and the other for receiving. In other embodiments of the invention, the RF transceiver comprises one oscillator, and the oscillator switches between transmitter mode and received mode.

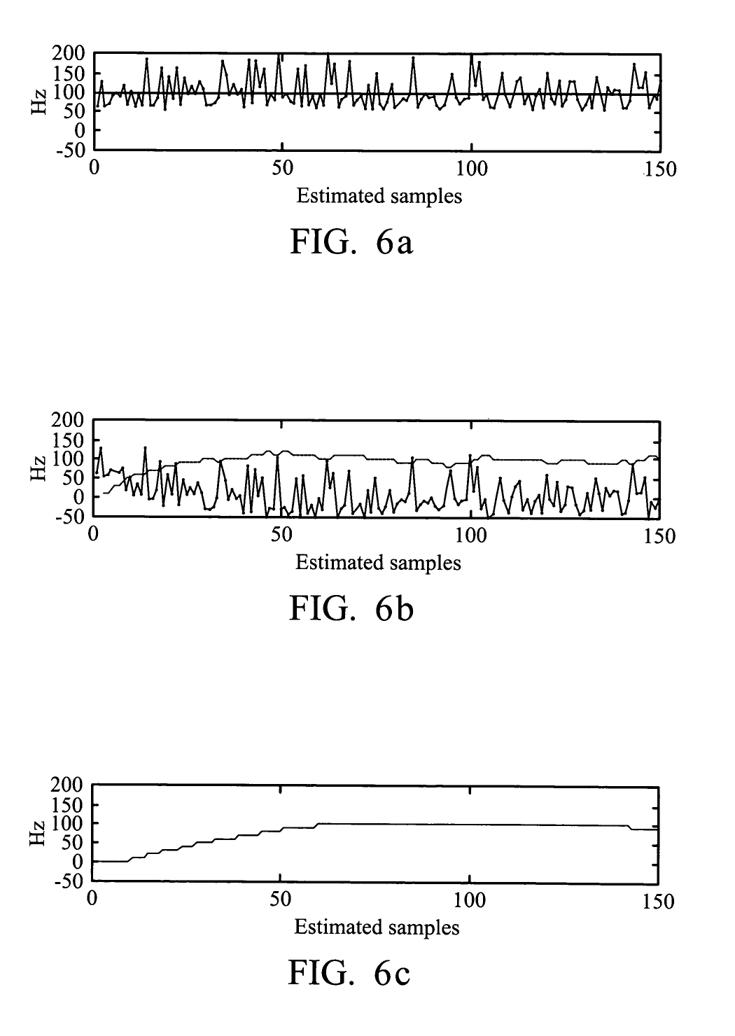

FIGS. 6a, 6b and 6c show time diagrams of the frequency of the downlink receiver oscillator and uplink transmitter oscillator. In FIG. 6a, the solid line represents the frequency offset between the initial downlink receiver oscillator and downlink transmitter oscillator, and the dash line shows the received frequency from the downlink channel. The received frequency varies with time and working environment. In FIG. 6b, dash line shows the frequency offset estimated by the frequency estimating module, and the solid line shows the adjusted frequency of the downlink receiver oscillator. Initially, the solid line in FIG. 6b rapidly approaches 100 Hz, than stays substantially the same with the received frequency. FIG. 6c shows the time diagram of the frequency of the uplink transmitter oscillator. The frequency of the uplink transmitter oscillator is a smoothed version of the downlink receiver oscillator. The frequency deviation of the downlink receiver oscillator and uplink transmitter oscillator is substantially kept constant.

The invention will become more fully understood from the detailed description, given herein below, and the accompanying drawings. The drawings and description are provided for purposes of illustration only, and, thus, are not intended to be limiting of the present invention.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for adjusting a radio communication device comprising a receiver oscillator and a transmitter oscillator, the method comprising:
obtaining the frequency offset between a first frequency and a carrier frequency of received signals, wherein the first frequency is generated by the receiver oscillator;
adjusting the first frequency at a first rate according to the frequency offset, wherein the first rate is a change of a frequency within a time unit; and
adjusting the transmitter oscillator at a second rate according to the first rate, wherein the first rate and the second rate are different.

2. The method as claimed in claim 1, wherein adjusting the first frequency comprises smoothing the changes of the first frequency to obtain a first adjusting signal to control the first frequency.

3. The method as claimed in claim 1, wherein adjusting the transmitter oscillator comprises:
smoothing the first adjusting signal to obtain a second adjusting signal; and
controlling the transmitter oscillator according to the second adjusting signal.

4. The method as claimed in claim 1, further comprising adjusting the transmitter oscillator at a second rate according to the first rate and the frequency offset.

5. The method as claimed in claim 1, wherein the first rate is faster than the second rate.

6. The method as claimed in claim 1, wherein the receiver oscillator is a downlink receiving oscillator, and the transmitter oscillator is an uplink transmitting oscillator.

7. An integrated circuit installed in a radio communication device, for communicating with a corresponding radio communication device, the integrated circuit comprising:
a down-converter comprising a receiver oscillator, generating a first frequency, and converting first signals into a plurality of second signals, wherein the first signals has a carrier frequency and are transmitted from the corresponding radio communication device;
a transmitter oscillator generating a transmitting frequency, and transmitting third signals with the transmitting frequency to the corresponding communication device;
a frequency offset estimating module obtaining the carrier frequency of the first signals according to the plurality of second signals, and calculating a frequency offset between the first frequency and the carrier frequency;
a first smoothing module generating a first adjusting signal according to the frequency offsets, wherein the first adjusting signal is sent to adjust the first frequency at a first rate, and the first rate is a change of a frequency within a time unit; and
a second smoothing module receiving the first adjusting signal to generate a second adjusting signal, wherein the second adjusting signal is sent to adjust the transmitting frequency at a second rate, and the first rate and the second rate are different.

8. The integrated circuit as claimed in claim 7, wherein the second smoothing module generates the second adjusting signal according to the frequency offset and the first rate.

9. The integrated circuit as claimed in claim 7, wherein the first rate is faster then the second rate.

10. The integrated circuit as claimed in claim 7, wherein the first smoothing module is a loop filter.

11. The integrated circuit as claimed in claim 7, wherein the receiver oscillator is a downlink receiving oscillator, and the transmitter oscillator is an uplink transmitting oscillator.

12. A radio communication device for communicating with a corresponding radio communication device, comprising:
a receiver oscillator generating a first frequency, and converting first signals into a plurality of second signals, wherein the first signal has a carrier frequency and are transmitted from the corresponding radio communication device;
a transmitter oscillator generating a transmitting frequency, and transmitting third signals with the transmitting frequency to the corresponding communication device; and
a processing unit, obtaining the carrier frequency of the first signals according to the plurality of second signals, calculating a frequency offsets between the first frequency and the carrier frequency, generating a first adjusting signal according to the calculated frequency offsets, wherein the first adjusting signal is sent to adjust the first frequency at a first rate, and receiving the first adjusting signal to generate a second adjusting signal, wherein the first rate is a change of a frequency within a time unit, and the second adjusting signal is send to adjust the transmitting frequency at a second rate, and the first rate and the second rate are different.

13. The radio communication device as claimed in claim 12, wherein the processing unit is a digital signal processor.

14. The radio communication device as claimed in claim 13, wherein the digital signal processor executes the programs comprising:
an frequency offset estimating module obtaining the carrier frequency of the first signals according to the plurality of second signals, and estimating the frequency offsets between the first frequency and the carrier frequency;
a first smoothing module generating a first adjusting signal according to the estimated frequency offset, wherein the first adjusting signal is sent to adjust the first frequency at a first rate, wherein the first rate is a change of a frequency within a time unit; and
a second smoothing module receiving the first adjusting signal to generate a second adjusting signal, wherein the second adjusting signal is sent to adjust the transmitting frequency at a second rate, and the first and second rate are different.

15. The radio communication device as claimed in claim 14, wherein the second smoothing module generates the second adjusting signal according to the frequency offsets and the first rate.

16. The radio communication device as claimed in claim 12, wherein the first rate is faster then the second rate.

17. The first radio communication device as claimed in claim 14, wherein the first smoothing module is a loop filter.

18. The first radio communication device as claimed in claim 12, wherein the receiver oscillator is a downlink receiving oscillator, and the transmitter oscillator is an uplink transmitting oscillator.
